(19) United States
(12) Patent Application Publication
(10) Pub. No.: US 2017/0202061 A1
(43) Pub. Date: Jul. 13, 2017

(54) LED LIGHT STRING HAVING SERIES-CONNECTED LIGHT BULBS WITH PARALLEL-CONNECTED LED CHIPS

(71) Applicant: FIBER OPTIC DESIGNS, INC., Yardley, PA (US)

(72) Inventor: David Allen, Yardley, PA (US)

(21) Appl. No.: 14/994,660

(22) Filed: Jan. 13, 2016

(51) Int. Cl. H05B 33/08; F21V 23/06; F21K 9/235; F21K 9/232; F21V 3/00; F21K 9/238; F21S 4/10; F21V 23/00

(52) U.S. Cl. CPC H05B 33/0809; H05B 33/0827; F21S 4/10; H05B 33/0887; F21V 23/06; F21V 23/001; F21K 9/232; F21V 3/00; F21K 9/238; F21K 9/235; F21V 23/005; F21Y 2115/10

(57) ABSTRACT

An LED light string is provided that includes at least an input connector electrically connectable to a source of an alternating current voltage, a rectifier configured to convert the alternating current voltage to direct current voltage, and a plurality of light bulbs connected in series to one another, at least one of the light bulbs comprising at least one LED array comprising a plurality of LED chips connected in parallel with one another. The LED light string may be useful, for example, as decorative lights and holiday decorations.

### BACKGROUND

1. Field of the Invention

The present invention relates to decorative light emitting diode (“LED”) light strings.

2. Description of the Related Art

LEDs have become very popular as a light source in decorative and holiday lights due to their reliability, energy savings, longevity, and cool operation.

It is known in the art the use of a DC power supply to power LED lamps maximize LED brightness and longevity. However, prior art discloses the use of a full bridge rectification circuit that requires additional wires and/or places undue current load on rectifying diodes, detracting from the appearance of the light string and creating a potential safety hazard.

Therefore, the decorative LED light strings are susceptible to improvements that may enhance their performance and cost. With this in mind, it would be useful to develop an LED light string with improved performance and brightness, that is relatively inexpensive, and that provides for cost effective and efficient illumination.

### BRIEF SUMMARY OF THE INVENTION

An LED light string according to an embodiment of the invention includes at least an input connector electrically connectable to a source of an alternating current voltage, a rectifier configured to convert the alternating current voltage to direct current voltage, and a plurality of light bulbs connected in series to one another, at least one of the light bulbs comprising at least one LED array comprising a plurality of LED chips connected in parallel to one another.

An LED light string according to a second embodiment of the invention includes an input connector electrically connectable to a source of an alternating current voltage, a rectifier configured to convert the alternating current voltage to direct current voltage, and a plurality of light bulbs connected in series to one another. At least one of the light bulbs comprises a plurality of LED arrays connected in parallel with one another. At least one of the LED arrays comprises a plurality of LED chips connected in parallel to one another.

Other aspects of the invention, including apparatus, devices, systems, other light strings, individual light bulbs, methods, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following detailed description when viewed in light of the accompanying drawings, in which like elements are given the same or analogous reference numerals and wherein:

FIG. 1 is an LED light string in accordance with a first exemplary embodiment of the present invention;

FIG. 2 is an LED light bulb of the LED light string of FIG. 1 in accordance with the first exemplary embodiment of the present invention;

FIG. 3A is a schematic circuit diagram illustrating the LED light string in accordance with the first exemplary embodiment of the present invention;

FIG. 3B is a schematic circuit diagram illustrating the LED light string in accordance with the first exemplary embodiment of the present invention connected to a common household AC input voltage source;

FIG. 4 is an enlarged view of a fragment of the LED light string shown in the circle 4 of FIG. 3A;

FIG. 5 is an LED light bulb in accordance with a second exemplary embodiment of the present invention;

FIG. 6A is a schematic circuit diagram illustrating an LED light string in accordance with the second exemplary embodiment of the present invention;

FIG. 6B is a schematic circuit diagram illustrating the LED light string in accordance with the second exemplary embodiment of the present invention connected to a common household AC input voltage source;

FIG. 7 is an enlarged view of a fragment of the LED light string shown in the circle 7 of FIG. 6A;

FIG. 8A is a schematic circuit diagram illustrating an LED light string in accordance with a third exemplary embodiment of the present invention;

FIG. 8B is a schematic circuit diagram illustrating the LED light string in accordance with the third exemplary embodiment of the present invention connected to a common household AC input voltage source;

FIG. 9 is an enlarged view of a fragment of the LED light string shown in the circle 9 of FIG. 8A;

FIG. 10 is an assembled view of an LED light bulb according to a fourth embodiment of the invention;

FIG. 11 is an exploded view of the LED light bulb of FIG. 10;

FIG. 12A is is a schematic circuit diagram illustrating the LED light string in accordance with the fourth exemplary embodiment of the present invention;

FIG. 12B is a schematic circuit diagram illustrating the LED light string in accordance with the fourth exemplary embodiment of the present invention connected to a common household AC input voltage source;

FIG. 13 is an enlarged view of a fragment of the LED light string shown in the circle 13 of FIG. 12A;

FIG. 14 is an assembled view of an LED light bulb according to a fifth embodiment of the invention;

FIG. 15 is an exploded view of the LED light bulb of FIG. 14;

FIG. 16A is a schematic circuit diagram illustrating the LED light string in accordance with the fifth exemplary embodiment of the present invention;

FIG. 16B is a schematic circuit diagram illustrating the LED light string in accordance with the fifth exemplary embodiment of the present invention connected to a common household AC input voltage source; and

FIG. 17 is an enlarged view of a fragment of the LED light string shown in the circle 17 of FIG. 16A.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “front”, “rear”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are coupled to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the word “a” and “an” as used in the claims means “at least one” and the word “two” as used in the claims means “at least two” unless expressly described otherwise.

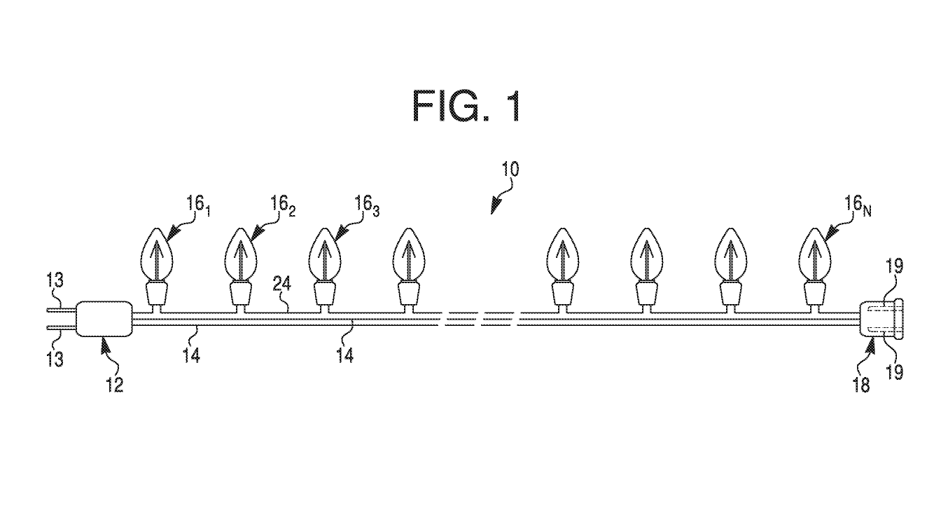

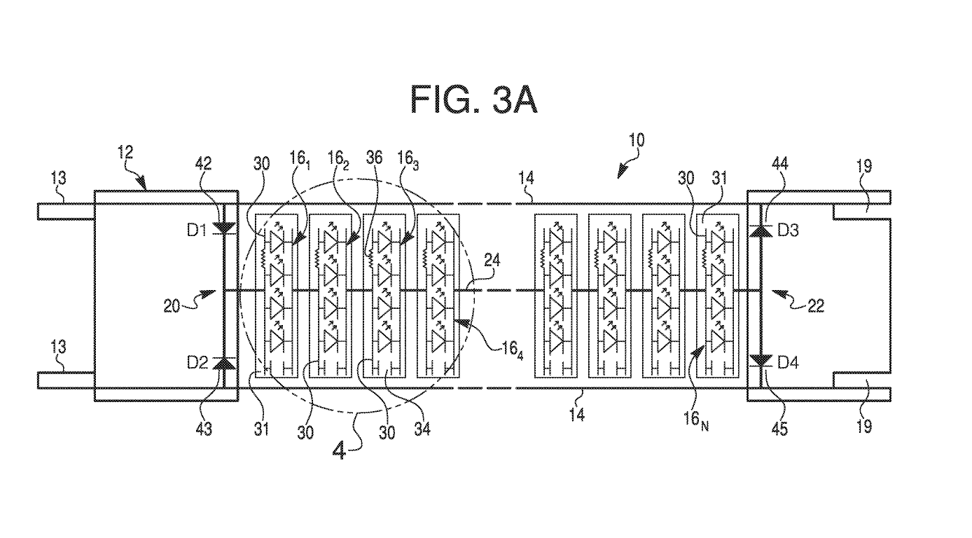

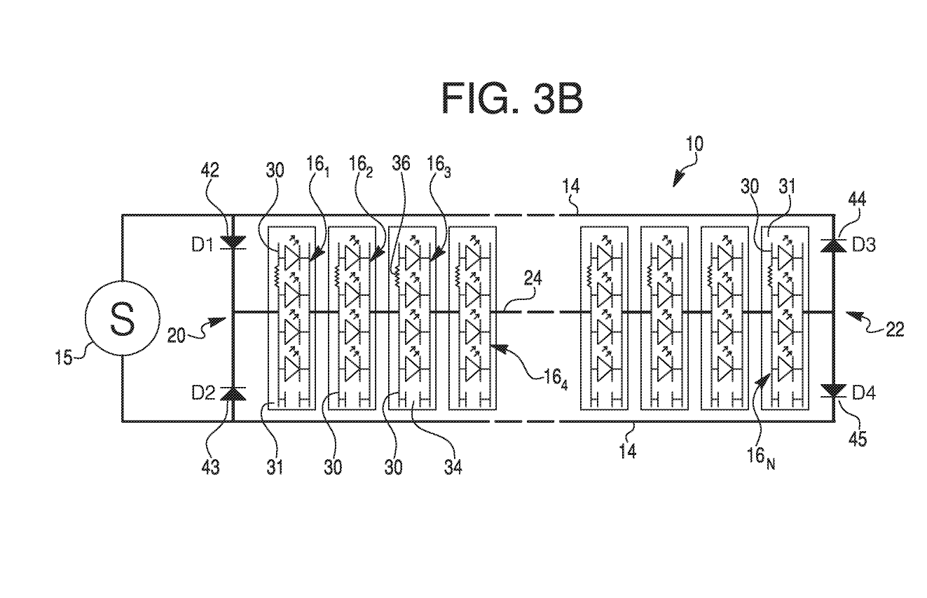

A first exemplary embodiment of a decorative or holiday LED light string is generally represented in the accompanying drawings by reference numeral 10, as best shown in FIG. 1. As further shown in FIGS. 1 and 3A, the LED light string 10 comprises an input electrical interface in the form of an AC household input (or first) connector 12, embodied as a plug, attached to AC parallel conductor wires (or drive wires) 14, a plurality of sealed decorative or holiday LED light bulbs 16₁-16_{N} connected in series to each other by series conductor wires 24, and an end connector 18, embodied as a socket, for powering additional LED light strings, for example, by daisy-chaining. As best shown in FIGS. 1 and 3A, the input connector plug 12 includes two (or three) prongs 13 configured to be electrically connected to a source of AC power, such as a power outlet (or power socket), while the end connector socket 18 includes two (or three) plug slots 19 configured to receive the input connector plug of another light string. As best shown in FIG. 3B, the input connector plug 12 is connectable to a common household AC input voltage source 15, while the end (or second) connector 18 is connectable to an input connector plug of another LED light string 10 to be conveniently connected together, using standard 110 VAC or 220 VAC plugs and sockets, desirably from end-to-end, e.g., daisy chained, for powering additional light strings. The LED light string 10 may be electrically powered from a common household 110 VAC or 220 VAC source.

The plurality of LED light bulbs 16₁-16_{N} may include two, three, four, five, six, or more light bulbs. In the illustrated embodiments, the LED light bulbs 16₁-16_{N} are substantially structurally and functionally similar, although it should be understood that the present invention may include light strings with LED light bulbs 16₁-16_{N} of different structure or functionality. In view of the similarities of the illustrated LED light bulbs 16₁-16_{N}, and in the interest of simplicity, the following discussion will occasionally use a reference numeral without a subscript number to designate any of the substantially identical LED light bulbs. For example, the reference numeral 16 will be used when generically referring to any of the LED light bulbs 16₁-16_{N} rather than reciting all reference numerals with subscripts.

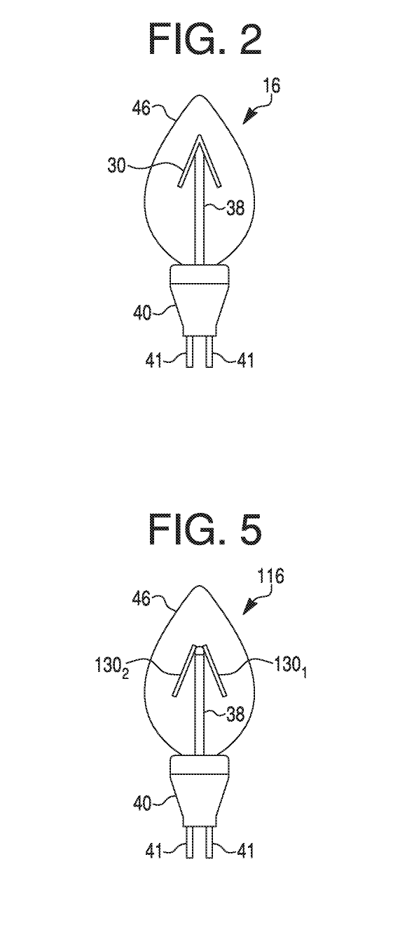

Each of the LED light bulbs 16 includes one or more LED arrays 30 mounted to a support member 38 (FIG. 2). According to the first exemplary embodiment of the present invention illustrated in FIG. 2, each of the LED light bulbs 16 includes a single LED array 30 mounted to the support member 38. In turn, the support member 38 is secured to a base (also known as a lamp holder) 40 providing electrical connections to the LED array 30.

The LED array 30 includes a plurality of LED chips 32₁-32_{N} connected in parallel to each other. The plurality of LED chips 32₁-32_{N} may include two, three, four, five, six, or more LED chips. In the illustrated embodiment, the LED chips 32₁-32_{N} are substantially structurally and functionally identical, although it should be understood that the present invention may include LED arrays 30 with LED chips 32₁-32_{N} that are not all substantially identical to one another. In view of these similarities, and in the interest of simplicity, the following discussion will occasionally use a reference numeral 32 without a subscript number to designate any of the substantially identical LED chips.

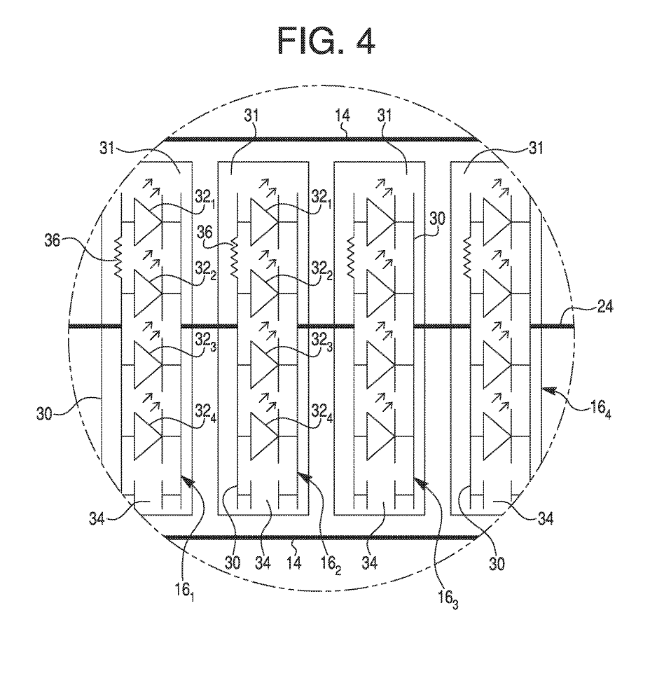

According to the first exemplary embodiment of the present invention, as best shown in FIGS. 3A, 3B and 4, the LED array 30 includes four LED chips 32₁-32₄ connected in parallel electrical arrangement to each other. However, more or less than four LED chips 32₁-32₄ electrically connected in parallel to one another may be employed in the same LED array 30 depending upon the relative dimensions and proportions of the particular design of the LED light bulb 16.

The decorative or holiday light bulbs 16 according to the exemplary embodiment of the present invention are shown using bi-post bases 40 with at least two posts 41 electrically connected to the LED chips 32 of the LED array 30. Although the LED light bulbs 16 of the exemplary embodiment employ the bi-post bases 40, it is to be realized that other bases, such as C6, C7 or C9, may be used. Each of the LED light bulbs 16 further includes a glass or plastic envelope (also referred to as a housing or cover) 46 placed around the one or more LED arrays 30 and the support member 38 and connected to the base 40, typically in a sealed manner. A method of sealing LEDs is described, for example, in U.S. Pat. No. 7,220,022.

According to the first exemplary embodiment of the present invention, the LED array 30 is in the form of a single PC (printed circuit) board 31 with the plurality of the LED chips 32 integrally secured thereto and electrically connected using conductive tracks of the PC board 31, as best shown in FIG. 4. Alternatively, the arrays 30 of the connected in parallel LED chips 32 may be mounted to a plurality of separate PC boards or any other relatively rigid boards. As another alternative, no board is used.

According to the first exemplary embodiment of the present invention, the appearance of the LED array 30 may closely resemble a filament of a conventional incandescent bulb, giving a unique appearance to the LED bulb as well as 360° illumination and viewing angle unlike conventional discrete LEDs.

The LED array 30 of each of the LED light bulbs 16 according to the exemplary embodiment of the present invention optionally includes a capacitor 34 installed in parallel to the LED array 30, as shown in FIGS. 3A, 3B and 4, to smooth AC ripple for greater array longevity and light output. The LED array 30 of each of the LED light bulbs 16 also optionally includes an electrical resistor 36 connected in series with the LED chips 32, as shown in FIGS. 3A, 3B and 4, to regulate electric current. Preferably, the capacitor 34 and the electrical resistor 36 are integrally secured to the PC board 31 and electrically connected using conductive tracks thereof. Alternatively, the electrical resistor 36 can be installed on the series conductor wires 24. It should be understood that the LED light string 10 may include the capacitor 34 but not the resistor 36, or conversely the resistor 36 but not the capacitor 34, or a combination thereof.

According to the first exemplary embodiment of the present invention, a front (or first) rectification circuit (or rectifier) component 20 is incorporated into or otherwise associated with the input connector plug 12. Further according to the exemplary embodiment of the present invention, a rear (or second) rectification circuit (or rectifier) component 22 is incorporated into or otherwise associated with the end connector socket 18, as best shown in FIG. 3A.

The front rectification circuit component 20 includes two front (or first) rectifying diodes 42 and 43 forming a first half of a rectifier circuit. Each of the front rectifying diodes 42 and 43 is connected to the AC parallel conductor wires 14 of the LED light string 10 and the plurality of the LED light bulbs 16 connected in series via the series conductor wires 24, as best shown in FIG. 3A. Similarly, the rear rectification circuit component 22 includes two rear (or second) rectifying diodes 44 and 45 forming a second half of the rectifier circuit. Each of the rear rectifying diodes 42 and 43 is connected to the AC parallel conductor wires 14 of the LED light string 10 and the plurality of the LED light bulbs 16 connected in series via the series conductor wires 24, as best shown in FIGS. 3A and 3B, thus completing the circuit. As further illustrated in FIG. 3A, each of the front and rear rectification circuit components 20 and 22 is electrically connected to the prongs 13 of the input connector plug 12. In other words, each of the front and rear rectification circuit components 20 and 22 is electrically connectable to the AC input voltage source 15, as shown in FIG. 3B. The front and rear rectification circuit components 20 and 22 in combination define a rectification circuit (rectifier) of the LED light string 10 electrically connected to the LED light bulbs 16 and to the input connector 12.

The LED light string 10 of the first exemplary embodiment of the present invention, and the light strings of other embodiments discussed below, allow operation directly from a standard household 110 VAC or 220 VAC source, without any additional circuitry. In addition, the LED light string 10 allows multiple LED light strings 10 to be conveniently connected together, using standard 110 VAC or 220 VAC plugs and sockets, desirably from end-to-end, e.g., daisy chained.

Therefore, the LED light string 10 according to the first exemplary embodiment of the present invention, including the front and rear rectification circuit components 20 and 22, and the series-connected LED light bulbs 16, may be directly driven by the AC source without requiring any current-limiting circuitry. FIG. 3B is a general schematic diagram showing the plurality of the LED light bulbs 16 directly connected to the AC input voltage source 15 only through the front and rear rectification circuit components 20 and 22.

Various modifications, changes, and alterations may be practiced with the above-described embodiment, including but not limited to the additional embodiments shown in FIGS. 5-9. In the interest of brevity, reference characters in FIGS. 5-9 that are discussed above in connection with FIGS. 1-4 are not further elaborated upon below, except to the extent necessary or useful to explain the additional embodiments of FIGS. 5-9. Modified components and parts are indicated by the addition of a hundred digits to the reference numerals of the components or parts.

In an LED light string 110 of a second exemplary embodiment illustrated in FIGS. 5-7, the plurality of sealed LED light bulbs 16₁-16_{N} is replaced by a plurality of sealed LED light bulbs 116₁-116_{N} connected in series to each other by series conductor wires 24. The LED light bulbs 16₁-16_{N} of FIGS. 1-4 according to the first exemplary embodiment correspond substantially to the LED light bulbs 116₁-116_{N} of FIGS. 5-7, and only the portions of the LED light bulbs 116₁-116_{N} that differ from light bulbs 16₁-16_{N} will therefore be explained in further detail below. In the second exemplary embodiment of the present invention illustrated in FIGS. 5-7, the LED light bulbs 116₁-116_{N} are substantially structurally and functionally similar to one another. In view of these similarities, and in the interest of simplicity, the following discussion will occasionally use a reference numeral without a subscript number to designate any of the substantially identical LED light bulbs. For example, the reference numeral 116 will be used when generically referring to any of the LED light bulbs 116₁-116_{N} rather than reciting all reference numerals. As with the first exemplary embodiment above, it should be understood that not all of the LED light bulbs 116₁-116_{N} are necessary substantially similar. For example, a combination of bulbs 16 and 116 may be used.

According to the second exemplary embodiment of the present invention, each of the LED light bulbs 116 includes a plurality of LED arrays 130₁-130_{N}. For simplicity sake, the drawings illustrate LED light bulbs 116 including two LED arrays 130₁ and 130₂ both mounted to the support member 38, as best shown in FIG. 5. It should be understood, however, that the LED light bulbs 116 may include two, three, four, or more LED arrays. In turn, the support member 38 is secured to the base 40 providing electrical connections to the LED arrays 130₁ and 130₂.

The LED arrays 130₁ and 130₂ of the LED light bulb 116 are substantially structurally and functionally identical to one another. In view of these similarities, and in the interest of simplicity, the following discussion will occasionally use the reference numeral 130 when generically referring to any of the LED arrays 130₁ and 130₂. Each of the LED arrays 130 of each of the LED light bulbs 116 includes a plurality (e.g., two, three, four, five, or more) of LED chips connected in parallel to each other.

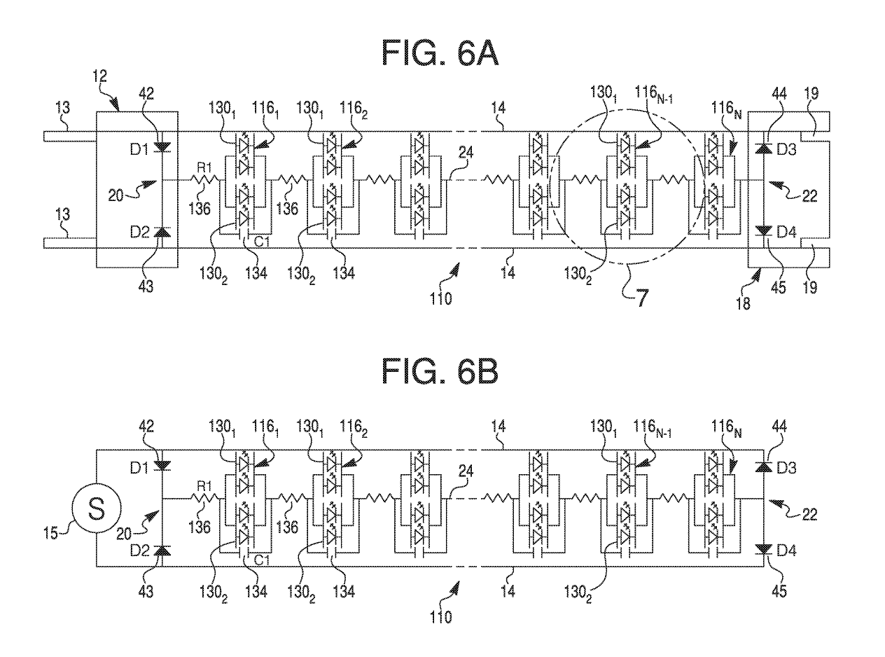

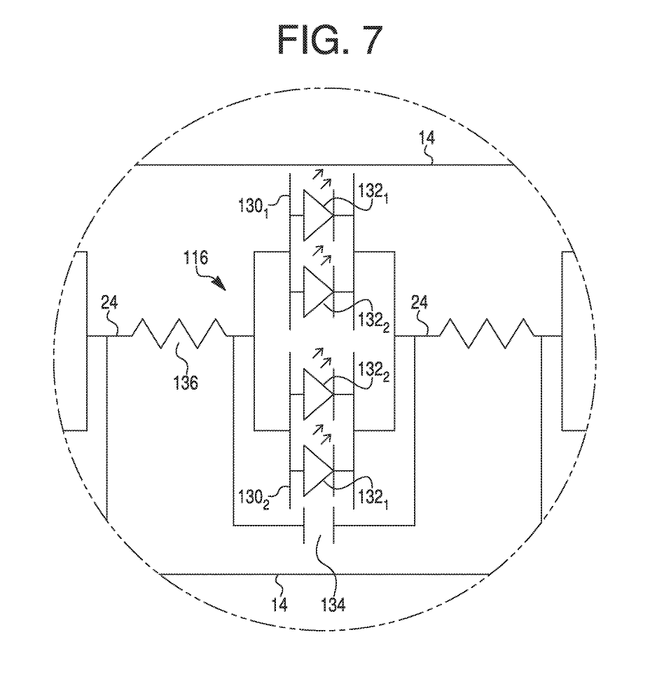

For the sake of simplicity, FIGS. 6A, 6B, and 7 illustrate each of the LED arrays 130 of the second exemplary embodiment including two LED chips 132₁ and 132₂ connected in parallel to each other. However, more than two LED chips 132₁-132₂ connected in parallel to each other may be employed depending upon the relative dimensions and proportions of the particular design of the LED light bulb 116.

The LED chips 132₁-132₂ are substantially structurally and functionally identical, although it should be understood that the present invention may include light bulbs 116 with LED chips 132₁-132_{N} that are different in structure or functionality from one another. In view of these similarities, and in the interest of simplicity, the following discussion will occasionally use a reference numeral 132 without a subscript number to designate any of the substantially identical LED light chips.

The holiday light bulbs 116 according to the second exemplary embodiment of the present invention are also shown using the bi-post bases 40 with the at least two posts 41 electrically connected to the LED chips 132 of the LED array 130. Although the LED light bulbs 116 of the second exemplary embodiment employ the bi-post bases 40, it is to be realized that other bases, such as C6, C7 or C9, may be used.

Each of the LED light bulbs 116 further includes a glass or plastic envelope (also referred to as a cover or housing) 46 placed around two LED arrays 130 and the support member 38 and connected to the base 40, optionally in a sealed manner.

Similarly to the first exemplary embodiment of the present invention, each of the LED arrays 130 according to the second exemplary embodiment is in the form of a PC (printed circuit) board with the plurality of the LED chips 132 integrally secured thereto and electrically connected using conductive tracks of the PC board. Alternatively, the arrays 130 of the connected in parallel LED chips 132 may be mounted to separate PC boards or any other relatively rigid boards. As a further alternative embodiment, no board is used. According to the second exemplary embodiment of the present invention, the appearance of the LED array 130 may closely resemble a filament of a conventional incandescent bulb, giving a unique appearance as well as 360° illumination and viewing angle unlike conventional discrete LEDs.

The LED array 130 of each of the LED light bulbs 116 according to the second exemplary embodiment of the present invention optionally includes a capacitor 134 installed in parallel to the LED arrays 130₁ and 130₂, as shown in FIGS. 6A, 6B and 7, to smooth AC ripple for greater array longevity and light output. Each of the LED light bulbs 116 also optionally includes an electrical resistor 136 installed on the series conductor wires 24, as shown in FIGS. 6A, 6B and 7, to regulate electric current. Alternatively, the electrical resistor 136 can be installed on the series conductor wires 24. It should be understood that the light string 110 may include the capacitor 134 but not the resistor 136, or conversely the resistor 136 but not the capacitor 134, or a combination thereof.

Similarly to the first exemplary embodiment of the present invention, the LED light string 110 of the second exemplary embodiment includes the front (or first) rectification circuit component 20 incorporated into (or otherwise associated with) the input connector plug 12 (best shown in FIG. 6A), and the rear (or second) rectification circuit component 22 incorporated into (or otherwise associated with) the end connector socket 18 (best shown in FIG. 6A).

The front rectification circuit component 20 includes two front (or first) diodes 42 and 43 forming a first half of a rectifier circuit. Each of the front diodes 42 and 43 is connected to the AC parallel conductor wires 14 of the LED light string 110 and the plurality of the LED light bulbs 116 connected in series via the series conductor wires 24, as best shown in FIGS. 6A and 6B. Similarly, the rear rectification circuit component 22 includes two rear (or second) diodes 44 and 45 forming a second half of the rectifier circuit. Each of the rear diodes 42 and 43 is connected to the AC parallel conductor wires 14 of the LED light string 110 and the plurality of the LED light bulbs 116 connected in series via the series conductor wires 24, as best shown in FIGS. 6A and 6B, thus completing the circuit.

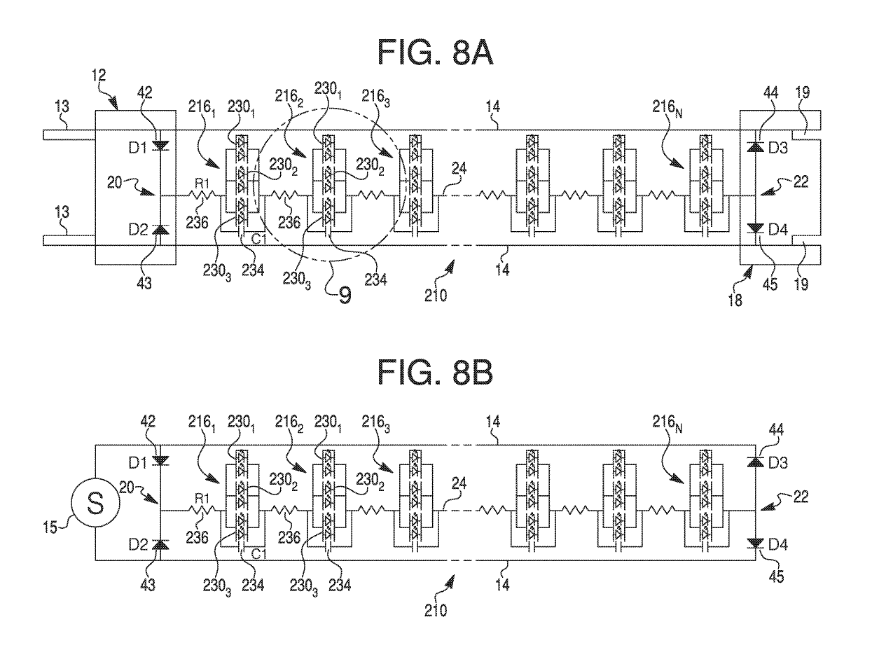

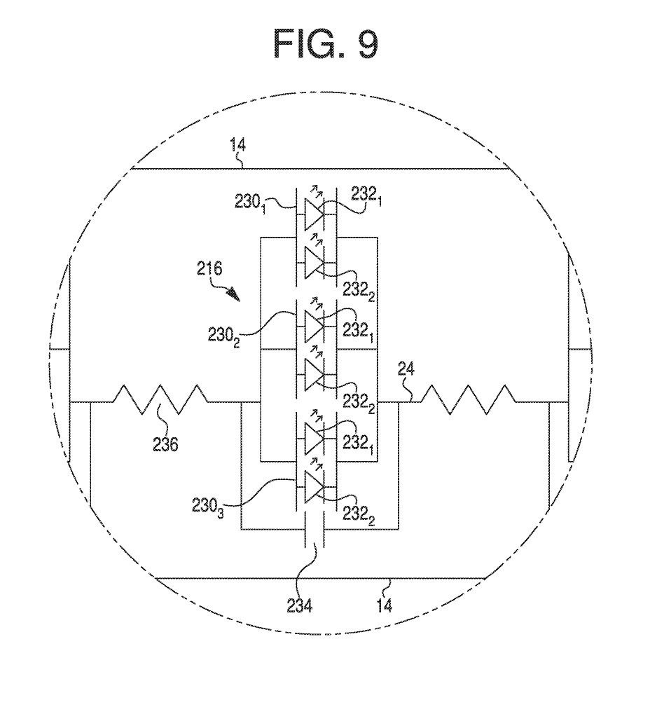

In an LED light string 210 of a third exemplary embodiment illustrated in FIGS. 8A, 8B and 9, the plurality of sealed LED light bulbs 116₁-116_{N} is replaced by a plurality of sealed LED light bulbs 216₁-216_{N} connected in series to each other by the series conductor wires 24. The LED light bulbs 16₁-16_{N} of FIGS. 1-4 of the first exemplary embodiment and the LED light bulbs 116₁-116_{N} of FIGS. 5-7 according to the second exemplary embodiment correspond substantially to the LED light bulbs 216₁-216_{N} of FIGS. 8A, 8B and 9, and only the portions of the LED light bulbs 216₁-216_{N} that differ from the description of corresponding parts above will therefore be explained in detail below. In the third exemplary embodiment of the present invention illustrated in FIGS. 8A, 8B and 9, the LED light bulbs 216₁-216_{N} are substantially structurally and functionally similar. In view of these similarities, and in the interest of simplicity, the following discussion will occasionally use a reference numeral without a subscript to designate any of the substantially identical LED light bulbs. For example, the reference numeral 216 will be used when generically referring to any of the LED light bulbs 216₁-216_{N} rather than reciting all reference numerals. It should be understood that the LED light bulbs 216₁-216_{N} of the light string 210 are not necessarily each substantially identical to one another.

According to the third exemplary embodiment of the present invention, each of the LED light bulbs 216 includes a plurality of LED arrays 230₁-230_{N}. For simplification purposes, FIGS. 8A, 8B, and 9 show the light bulbs 216 with three LED arrays 230₁, 230₂ and 230₃ all mounted to a support member (such as the support member 38 shown in FIG. 5), which, in turn, is secured to a base (such as the base 40 shown in FIG. 5) providing electrical connections to the LED arrays 230₁, 230₂ and 230₃.

The LED arrays 230₁, 230₂ and 230₃ of the LED light bulb 216 are substantially structurally and functionally identical to one another. In view of these similarities, and in the interest of simplicity, the following discussion will occasionally use the reference numeral 230 when generically referring to any of the LED arrays 230₁, 230₂ and 230₃. Each of the LED arrays 230 of each of the LED light bulbs 216 includes a plurality of LED chips connected in parallel to each other. It should be understood that LED arrays 230₁-230_{N} are not necessarily substantially structurally and functionally identical to one another.

According to the third exemplary embodiment of the present invention, as best shown in FIGS. 8A, 8B and 9, each of the LED arrays 230 includes two LED chips 232₁ and 232₂ connected in parallel to each other. However, more than two LED chips 232₁-232₂ connected in parallel to each other may be employed depending upon the relative dimensions and proportions of the particular design of the LED light bulb 216. The LED chips 232₁-232₂ are substantially structurally and functionally identical. In view of these similarities, and in the interest of simplicity, the following discussion will occasionally use a reference numeral 232 without a subscript number to designate any of the substantially identical LED light chips. It should be understood that LED chips 232₁-232₂ are not necessarily substantially structurally and functionally identical to one another. Moreover, the LED chips 232₁-232₂ may be substantially different in color so as to provide the light string 210 with color changing and/or color blending functions.

The holiday light bulbs 216 according to the third exemplary embodiment of the present invention are also shown using the bi-post bases 40 with the at least two posts 41 electrically connected to the LED chips 232 of the LED array 230. Although the LED light bulbs 216 of the third exemplary embodiment employ the bi-post bases (such as the bi-post base 40 shown in FIG. 5), it is to be realized that other bases, such as C6, C7 or C9, may be used.

Each of the LED light bulbs 216 further includes a glass or plastic envelope (also referred to as a housing or cover) 46 placed around the three LED arrays 230 and the support member 38 and connected to the base 40, optionally in a sealed manner (similar to shown in FIG. 5).

Similarly to the first exemplary embodiment of the present invention, each of the LED arrays 230 according to the third exemplary embodiment may be in the form of a PC (printed circuit) board with the plurality of the LED chips 232 integrally secured thereto and electrically connected using conductive tracks of the PC board. Alternatively, the arrays 230 of the connected in parallel LED chips 232 may be mounted to separate PC boards or any other relatively rigid boards. Alternatively, no board is used.

According to the third exemplary embodiment of the present invention, the appearance of each of the three LED arrays 230 may closely resemble a filament of a conventional incandescent bulb giving a unique appearance as well as 360° illumination and viewing angle unlike conventional discrete LEDs.

The LED array 230 of each of the LED light bulbs 216 according to the third exemplary embodiment of the present invention optionally includes a capacitor 234 installed in parallel to the LED array 230, as shown in FIGS. 8A, 8B and 9, to smooth AC ripple for greater array longevity and light output. Each of the LED light bulbs 216 also optionally includes an electrical resistor 236 installed on the series conductor wires 24, as shown in FIGS. 8A, 8B and 9, to regulate electric current. Alternatively, the electrical resistor 236 can be installed on the series conductor wires 24. It should be understood that the light string 210 may include the capacitor 234 but not the resistor 236, or conversely the resistor 236 but not the capacitor 234, or a combination thereof.

Similarly to the first exemplary embodiment of the present invention, the LED light string 210 of the third exemplary embodiment includes the front (or first) rectification circuit component 20 is incorporated into or otherwise associated with the input connector plug 12 (best shown in FIG. 8A), and the rear (or second) rectification circuit component 22 is incorporated into or otherwise associated with the end connector socket 18 (best shown in FIG. 8A).

The front rectification circuit component 20 includes the two front (or first) diodes 42 and 43 forming the first half of the rectifier circuit. Each of the front diodes 42 and 43 is connected to the AC parallel conductor wires 14 of the LED light string 210 and the plurality of the LED light bulbs 216 connected in series via the series conductor wires 24, as best shown in FIG. 8. Similarly, the rear rectification circuit component 22 includes the two rear (or second) diodes 44 and 45 forming the second half of the rectifier circuit. Each of the rear diodes 42 and 43 is connected to the AC parallel conductor wires 14 of the LED light string 210 and the plurality of the LED light bulbs 216 connected in series via the series conductor wires 24, as best shown in FIGS. 8A and 8B, thus completing the circuit.

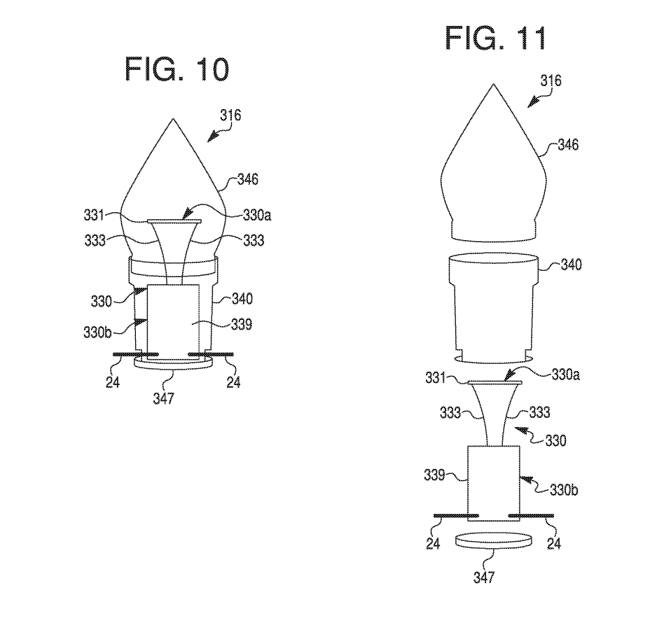

In an LED light string 310 of a fourth exemplary embodiment illustrated in FIGS. 10-13, the plurality of sealed LED light bulbs 16₁-16_{N} (as in the first embodiment, see FIG. 1) is replaced by a plurality of sealed LED light bulbs 316₁-316_{N} connected in series to each other by series conductor wires 24. The LED light bulbs 16₁-16_{N} of FIGS. 1-4 according to the first exemplary embodiment correspond substantially to the LED light bulbs 316₁-316_{N} of FIGS. 10-13, and only the portions of the LED light bulbs 316₁-316_{N} that differ from light bulbs 16₁-16_{N} will therefore be explained in further detail below. In the fourth exemplary embodiment of the present invention illustrated in FIGS. 10-13, the LED light bulbs 316₁-316_{N} are substantially structurally and functionally similar to one another. In view of these similarities, and in the interest of simplicity, the following discussion will occasionally use a reference numeral without a subscript number to designate any of the substantially identical LED light bulbs. For example, the reference numeral 316 will be used when generically referring to any of the LED light bulbs 316₁-316_{N} rather than reciting all reference numerals. As with the first exemplary embodiment above, it should be understood that not all of the LED light bulbs 316₁-316_{N} are necessary substantially similar to one another. For example, a combination of bulbs 16, 116, 216 and/or 316 may be used.

According to the fourth exemplary embodiment of the present invention, each of the LED light bulbs 316 includes an LED array assembly 330 comprising a single LED array 330a and, optionally, an LED driver 330b that performs circuit conditioning and control.

The single LED array 330a includes a plurality of LED chips 32₁-32_{N} connected in parallel to each other. The plurality of LED chips 32₁-32_{N} may include two, three, four, five, six, or more LED chips. In the illustrated embodiment, the LED chips 32₁-32_{N} are substantially structurally and functionally identical, although it should be understood that the present invention may include LED arrays 330a with LED chips 32₁-32_{N} that are not all substantially identical to one another. In view of these similarities, and in the interest of simplicity, the following discussion will occasionally use a reference numeral 32 without a subscript number to designate any of the substantially identical LED chips.

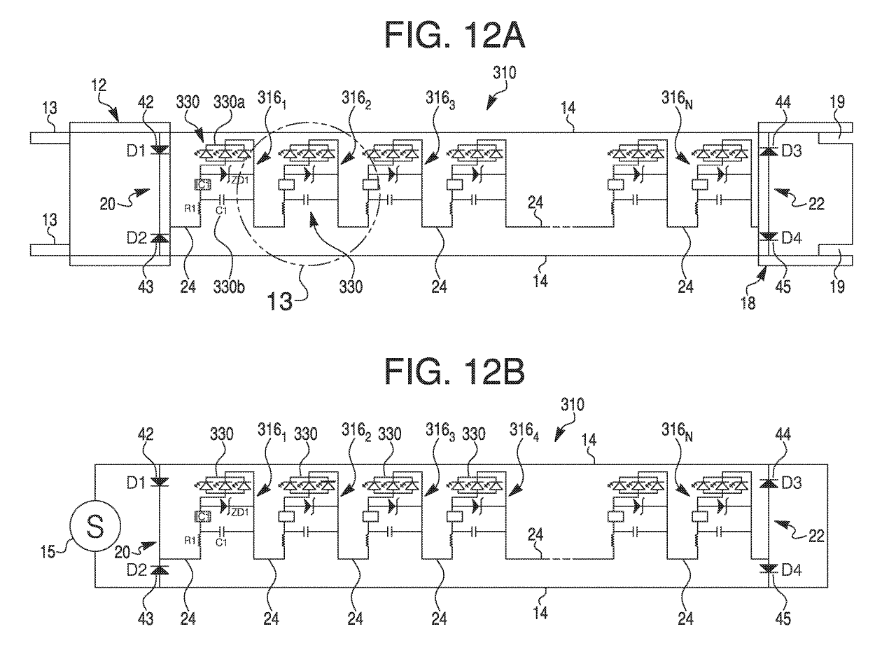

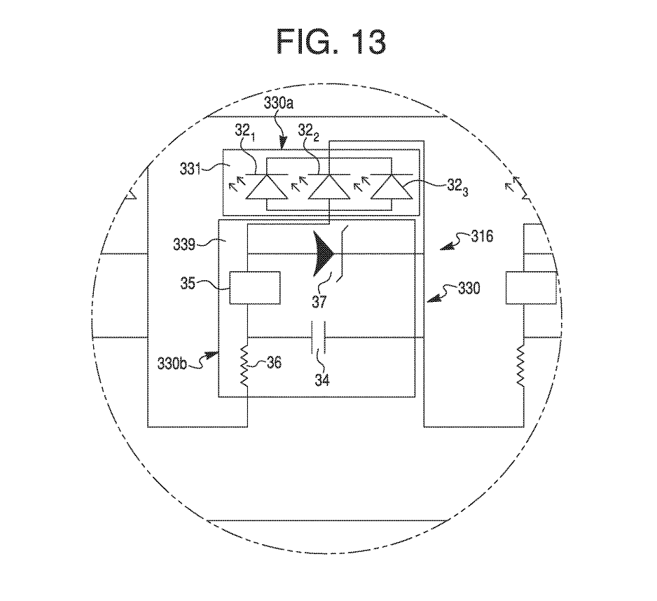

According to the fourth exemplary embodiment of the present invention, as best shown in FIGS. 12A, 12B and 13, the single LED array 330a includes three LED chips 32₁-32₃ connected in parallel electrical arrangement to each other. However, more or less than three LED chips 32₁-32₃ electrically connected in parallel to one another may be employed in the same LED array 330 depending upon the relative dimensions and proportions of the particular design of the LED light bulb 316.

The LED array 330a is embodied as a single LED PC (printed circuit) board 331 (also referred to as LED PCB) with the plurality of the LED chips 32 integrally secured thereto and electrically connected using conductive tracks of the PC board 331, as best shown in FIG. 13. The appearance of the LED array 330a may closely resemble a filament of a conventional incandescent bulb, giving a unique appearance to the LED bulb as well as 360° illumination and viewing angle unlike conventional discrete LEDs.

The LED driver 330b of each of the LED array assembly 330 according to the exemplary embodiment of the present invention optionally includes a capacitor 34 installed parallel to the LED array 330a, as best shown in FIG. 13, to smooth AC ripple for greater array longevity and light output. The LED driver 330b of each of the LED light bulbs 316 also optionally includes an integrated circuit 35 (also referred to as an IC, or a microchip) to perform more complex functions such as constant current control, flashing, fading, chasing functions, dimming and blending of sub-die, etc. The LED driver 330b of each of the LED light bulbs 316 also optionally includes an electrical resistor 36 connected in series with the LED chips 32, as best shown in FIG. 13, to regulate electric current. An optional Zener diode (or ZD) 37 acts as a shunt to protect the light string 310 against over current or failure in the event of a catastrophic failure of the lighting array or arrays 330a. The IC 35, the ZD 37, or a combination of the IC 35 and ZD 37 of this fourth embodiment may be incorporated into the light bulbs of and used in connection with the other embodiments described herein.

Preferably, the capacitor 34, the IC 35, the electrical resistor 36 and the Zener diode 37 are integrally secured to a driver PC board 339 (also referred to as a driver PCB) and electrically connected using conductive tracks thereof, as best shown in FIG. 13. It should be understood that the LED driver 330b may or may not include at least one of the capacitor 34, the IC 35, the electrical resistor 36 and the Zener diode 37, or a combination thereof.

Unlike the LED light string 10 according to the first exemplary embodiment of the present invention, the LED PCB 331 of the LED array 330a is separate from the driver PCB 339 of the LED driver 330b, as further shown in FIG. 13. As best shown in FIGS. 10-11, the LED array 330a is electrically connected to the LED driver 330b using electrodes 333.

Each of the decorative or holiday light bulbs 316 according to the fourth exemplary embodiment of the present invention, as best shown in FIGS. 10-11, comprises a hollow insulating lamp husk 340 housing the LED driver 330b with the driver PCB 339, a transparent or opaque envelope (also referred to as a cover) 346 mounted to the lamp husk 340 and housing the LED array 330a with the LED PCB 331, and an insulating end cap 347 connected to the lamp husk 340. The lamp husk 340, the cover 346 and the insulating end cap 347 are all typically connected to each other in a sealed manner. The cover 346 of this and other embodiments may be made of glass or plastic, such as a polycarbonate. The insulating end cap 347 may be made of, for example, polypropylene.

An exemplary method for manufacturing the light bulbs 316 according to the embodiment of FIGS. 10-13 will now be explained.

It should be understood that this exemplary method may be practiced in connection with the other embodiments described herein. This exemplary method is not the exclusive method for manufacturing the LED light bulbs described herein. While the methods for assembling the LED light bulbs 316 may be practiced by sequentially performing the steps as set forth below, it should be understood that the methods may involve performing the steps in different sequences.

The LED array 330a and the driver PCB 339 may each be preassembled. The LED array 330a is electrically connected to the LED driver 330b using electrodes 333 so as to form the LED array assembly 330. The final assembly of the LED array assembly 330 can be accomplished using automated manufacturing methods as conductor wires can be automatically positioned and soldered onto the driver PCB's, lighting arrays can also be auto soldered onto the driver PCB 339. Testing can be done prior to final assembly of individual light bulbs 316 so that defects are avoided.

Next, the LED PCB 331 is inserted into the hollow insulating lamp husk 340 so that the LED array 330a extends outwardly from the lamp husk 340. Then, the cover 346 is secured to the lamp husk 340 in a sealed manner so that the LED array 330a is disposed within the cover 346. After that, the insulating end cap 347 is secured to a lower end of the lamp husk 340 in a sealed manner.

The method for manufacturing the LED light bulbs 316 may utilize automated assembly wherein the LED array assembly 330 comprised of the LED PCB 331 and the driver PCB 339, electrodes, and conductor wires are inserted into the insulating lamp husk 340 and then sealed using the transparent or opaque cover 346 and the insulating end cap 347. These components can be affixed in a number of manners including but not limited to pressed fit, clips, adhesive, direct insert or injection molding, and potting.

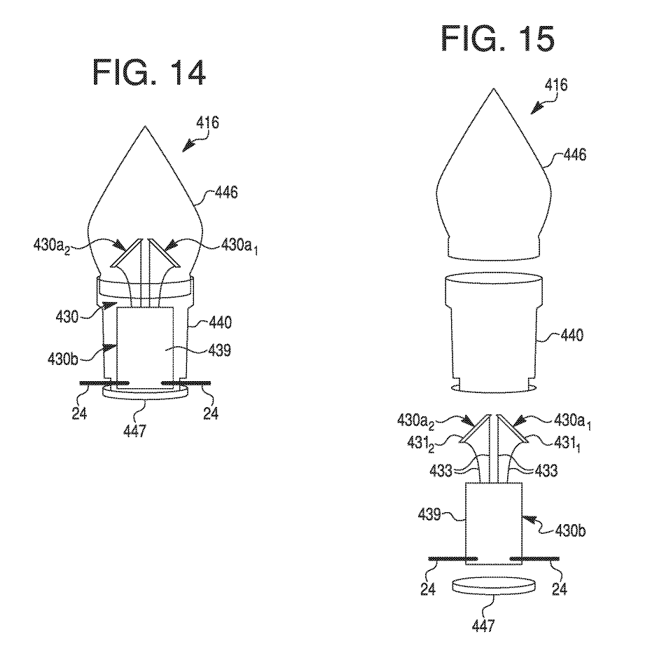

In an LED light string 410 of a fifth exemplary embodiment illustrated in FIGS. 14-17, the plurality of sealed LED light bulbs 316₁-316_{N} of the fourth embodiment is replaced by a plurality of sealed LED light bulbs 416₁-416_{N} connected in series to each other by series conductor wires 24. The LED light bulbs 316₁-316_{N} of FIGS. 10-13 according to the fourth exemplary embodiment correspond substantially to the LED light bulbs 416₁-416_{N} of FIGS. 14-17, and only the portions of the LED light bulbs 416₁-416_{N} that differ from light bulbs 316₁-316_{N} will therefore be explained in further detail below. In the fifth exemplary embodiment of the present invention illustrated in FIGS. 14-17, the LED light bulbs 416₁-416_{N} are substantially structurally and functionally similar to one another. In view of these similarities, and in the interest of simplicity, the following discussion will occasionally use a reference numeral without a subscript number to designate any of the substantially identical LED light bulbs. For example, the reference numeral 416 will be used when generically referring to any of the LED light bulbs 416₁-416_{N} rather than reciting all reference numerals. As with the fourth exemplary embodiment above, it should be understood that not all of the LED light bulbs 416₁-416_{N} are necessary substantially similar. For example, a combination of bulbs 16, 116, 216, 316 and 416 may be used.

According to the fifth exemplary embodiment of the present invention, each of the LED light bulbs 416 includes an LED array assembly 430 comprising two LED arrays 430a₁ and 430a₂, and, optionally, a single LED driver 430b that performs circuit conditioning and control of the LED arrays 430a₁ and 430a₂, as best shown in FIGS. 14-15. It should be understood, however, that the LED light bulbs 416 may include two, three, four, or more LED arrays.

The LED arrays 430a₁ and 430a₂ of the LED light bulb 416 are substantially structurally and functionally identical to one another. In view of these similarities, and in the interest of simplicity, the following discussion will occasionally use the reference numeral 430a when generically referring to any of the LED arrays 430a₁ and 430a₂.

Each of the LED arrays 430a includes a plurality of LED chips 32₁-32_{N} connected in parallel to each other. The plurality of LED chips 32₁-32_{N} may include two, three, four, five, six, or more LED chips. In the illustrated embodiment, the LED chips 32₁-32_{N} are substantially structurally and functionally identical, although it should be understood that the present invention may include LED arrays 430a with LED chips 32₁-32_{N} that are not all substantially identical to one another. In view of these similarities, and in the interest of simplicity, the following discussion will occasionally use a reference numeral 32 without a subscript number to designate any of substantially identical LED chips.

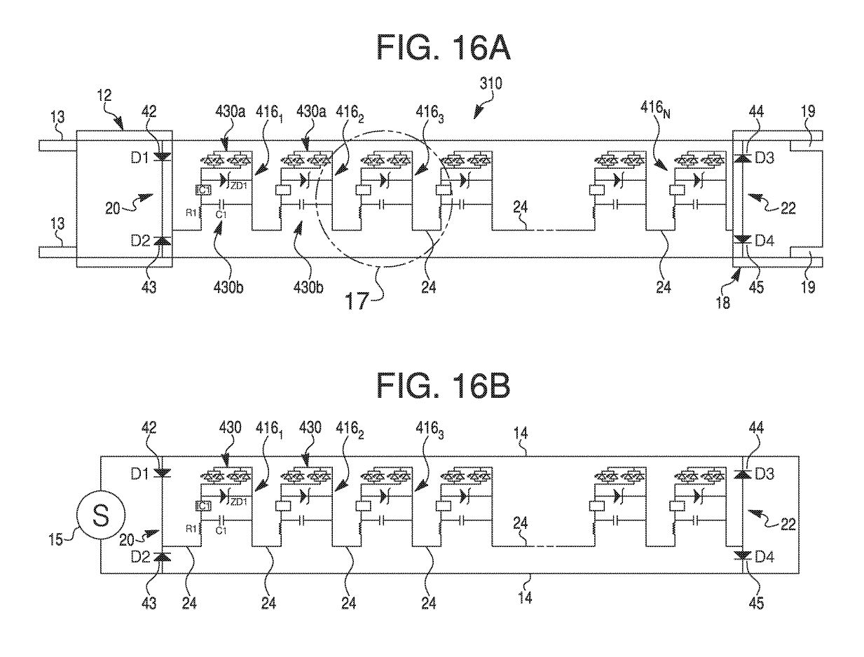

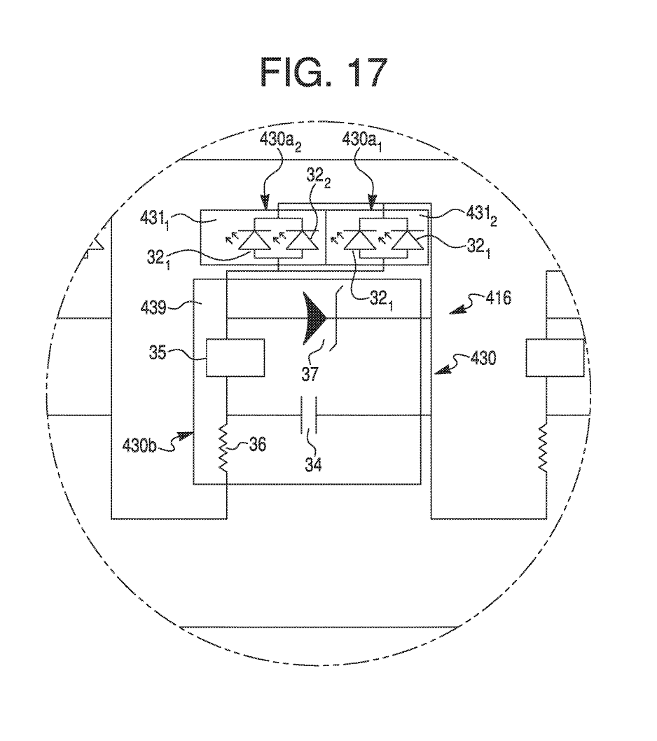

As best shown in FIGS. 16A, 16B and 17, each of the LED arrays 430a includes two LED chips 32₁-32₂ connected in parallel electrical arrangement to each other. However, more than two LED chips 32₁-32₂ electrically connected in parallel to one another may be employed in the same LED array 430a depending upon the relative dimensions and proportions of the particular design of the LED light bulb 416. Moreover, the LED chips 32₁-32₂ may be substantially different in color so as to provide the light string 410 with color changing and/or color blending functions.

According to the fourth exemplary embodiment of the present invention, the LED array 430a is embodied as a single LED PC (printed circuit) board 431 (also referred to as LED PCB) with the plurality of the LED chips 32 integrally secured thereto and electrically connected using conductive tracks of the PC board 431, as best shown in FIG. 17. The appearance of the LED array 430a may closely resemble a filament of a conventional incandescent bulb, giving a unique appearance to the LED bulb 416 as well as 360° illumination and viewing angle unlike conventional discrete LEDs.

The LED driver 430b of each of the LED array assembly 430 according to the fifth exemplary embodiment of the present invention optionally includes a capacitor 34 installed in parallel to the LED arrays 430a₁ and 430a₂, as best shown in FIG. 17, to smooth AC ripple for greater array longevity and light output. The LED driver 430b of each of the LED light bulbs 416 also optionally includes an integrated circuit 35 (also referred to as an IC, or a microchip) to perform more complex functions such as constant current control, flashing, fading, chasing functions, dimming and blending of sub-die, etc. The LED driver 430b of each of the LED light bulbs 416 also optionally includes an electrical resistor 36 connected in series with the LED chips 32, as best shown in FIG. 17, to regulate electric current. An optional Zener diode (or ZD) 37 acts as a shunt to protect the light string 410 against over current or failure in the event of a catastrophic failure of the lighting array or arrays 430a₁ and 430a₂.

As illustrated in FIG. 17, the capacitor 34, the IC 35, the electrical resistor 36, and the Zener diode 37 are integrally secured to a driver PC board 439 (also referred to as driver PCB) and electrically connected using conductive tracks thereof, as best shown in FIG. 17. It should be understood that the LED driver 430b may or may not include at least one of the capacitor 34, the IC 35, the electrical resistor 36 and the Zener diode 37, or a combination thereof.

Unlike the LED light string 110 according to the second exemplary embodiment of the present invention, the LED PCBs 431₁ and 431₂ of the LED arrays 430a₁ and 430a₂ are separate from the driver PCB 439 of the LED driver 430b, as further shown in FIG. 17. As best shown in FIGS. 14 and 15, each of the LED arrays 430a₁ and 430a₂ is electrically connected to the LED driver 430b using respective electrodes 433.

Each of the decorative or holiday light bulbs 416 according to the fifth exemplary embodiment of the present invention, as best shown in FIGS. 14 and 15, comprises a hollow insulating lamp husk 440 housing the LED driver 430b with the driver PCB 439, a transparent or opaque envelope (also referred to as a cover) 446 mounted to the lamp husk 340 and housing the LED arrays 430a₁ and 430a₂ with the LED PCBs 431, and an insulating end cap 447 connected to the lamp husk 440. The lamp husk 440, the cover 446, and the insulating end cap 447 are all typically connected to each other in a sealed manner. The cover 446 is made of glass or plastic.

An exemplary method for manufacturing the light bulbs 416 according to the embodiment of FIGS. 14-17 is substantially similar to the exemplary method for manufacturing the light bulbs 316 according to the embodiment of FIGS. 10-13 as described above.

The foregoing description of the exemplary embodiment(s) of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. An LED light string comprising:
an input connector electrically connectable to a source of an alternating current voltage;
an end connector socket;
a rectifier configured to convert the alternating current voltage to direct current voltage, the rectifier comprising a first rectification circuit component in electrical communication with the input connector and a second rectification circuit component in electrical communication with the end connector socket; and
a plurality of light bulbs connected in series to one another between the input connector and the end connector socket, at least one of the light bulbs comprising at least one LED array comprising a plurality of LED chips connected in parallel with one another.

2. The LED light string of claim 1, wherein each of the plurality of light bulbs connected in series to one another comprises at least one LED array comprising a plurality of LED chips connected in parallel with one another.

3. The LED light string of claim 1, wherein the at least one LED array of the at least one of the light bulbs further comprises a resistor connected in series with the LED chips.

4. The LED light string of claim 1, wherein the at least one LED array of the at least one of the light bulbs further comprises a capacitor connected in parallel with the LED chips.

5. The LED light string of claim 1, wherein the at least one LED array is embodied as an LED printed circuit board with the plurality of the LED chips integrally secured thereto.

6. (canceled)

7. An LED light string, comprising:
an input connector electrically connectable to a source of an alternating current voltage;
an end connector socket;
a rectifier configured to convert the alternating current voltage to direct current voltage, the rectifier comprising a first rectification circuit component incorporated into the input connector and a second rectification circuit component incorporated into the end connector socket; and
a plurality of light bulbs connected in series to one another between the input connector and the end connector socket, at least one of the light bulbs comprising a plurality of LED arrays connected in parallel to one another, at least one of the LED arrays of the plurality of LED arrays comprising a plurality of LED chips connected in parallel with one another.

8. The LED light string of claim 7, wherein each of the plurality of light bulbs connected in series to one another comprises a plurality of LED arrays connected in parallel to one another.

9. The LED light string of claim 8, wherein each of the LED arrays of the plurality of LED arrays comprises a plurality of LED chips connected in parallel with one another.

10. The LED light string of claim 7, wherein each of the LED arrays of the at least one of the light bulbs further comprises a resistor connected in series with the LED chips.

11. The LED light string of claim 7, wherein each of the LED arrays of the at least one of the light bulbs further comprises a capacitor connected in parallel with the LED chips.

12. The LED light string of claim 7, wherein the at least one of the LED arrays is embodied as an LED printed circuit board with the plurality of the LED chips integrally secured thereto.

13. (canceled)

14. An LED light string, comprising:
an input connector electrically connectable to a source of an alternating current voltage;
an end connector socket;
a rectifier configured to convert the alternating current voltage to direct current voltage, the rectifier comprising a first rectification circuit component incorporated into the input connector and a second rectification circuit component incorporated into the end connector socket; and
a plurality of light bulbs connected in series to one another between the input connector and the end connector socket, at least one of the light bulbs comprising at least three LED arrays connected in parallel to one another, at least one of the at least three LED arrays comprising a plurality of LED chips connected in parallel with one another.

15. The LED light string of claim 14, wherein each of the plurality of light bulbs connected in series to one another comprises at least three LED arrays connected in parallel to one another.

16. The LED light string of claim 15, wherein each of the at least three LED arrays of the plurality of LED arrays comprises a plurality of LED chips connected in parallel with one another.

17. The LED light string of claim 14, wherein each of the LED arrays of each of the light bulbs further comprises a resistor connected in series with the LED chips.

18. The LED light string of claim 14, wherein each of the LED arrays of each of the light bulbs further comprises a capacitor connected in parallel with the LED chips.

19. The LED light string of claim 14, wherein the at least one of the at least three LED arrays is embodied as an LED printed circuit board with the plurality of the LED chips integrally secured thereto.

20. (canceled)

21. The LED light string of claim 1, wherein the rectifier is configured for full-wave rectification.

22. The LED light string of claim 1, wherein the first rectification circuit component is incorporated into the input connector and second rectification circuit component is incorporated into the end connector socket.

23. The LED light string of claim 7, wherein the rectifier is configured for full-wave rectification.

24. The LED light string of claim 14, wherein the rectifier is configured for full-wave rectification.
